(19) United States
(12) Patent Application Publication
(10) Pub. No.: US 2015/0340181 A1
(43) Pub. Date: Nov. 26, 2015

(54) REFLOWABLE THERMAL FUSE

(71) Applicant: POLYTRONICS TECHNOLOGY CORP., Hsinchu (TW)

(72) Inventors: Chien Cheng HO, Hsinchu (TW); David Shau Chew WANG, Taipei City (TW)

(21) Appl. No.: 14/613,981

(22) Filed: Feb. 4, 2015

(30) Foreign Application Priority Data
May 22, 2014 (TW) 103117885

(51) Int. Cl. H01H 37/76

(52) U.S. Cl. CPC H01H 37/761; H01H 2037/762

(57) ABSTRACT

A reflowable thermal fuse comprises a base, a housing, an elastic conductive element, a sensor and a restraining element. The base comprises first and second bonding pads and combines with the housing to form an internal accommodating space in which the elastic conductive element has first and second ends connecting to the first and second bonding pads, respectively. The elastic conductive element is operable to exert a resilient force which is able to sever the connection between the second end and the second bonding pad. The sensor connects to the second end and the second bonding pad to form electrical connection. The restraining element comprises a pressing member going through an opening of the housing and pressing the second end to resist the resilient force during reflow. After reflow, the restraining element is removed and thereby the reflowable thermal fuse is in an activation condition.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present application relates to a thermal fuse, and more specifically to a reflowable thermal fuse.

2. Description of Related Art Including Information Disclosed Under 37 CFR 1.97 and 37 CFR 1.98.

With the advancement of scientific technology, electrical and electronic products become more diverse and complicated over time. The applicable circuit protection devices are not limited to traditional glass tube fuses, and have been devised to include a variety of electronic devices. The reliability and safety of the electronic products of new generations are highly demanded, and thus people pay close attention to the progresses of applicable circuit protection devices.

With the need of circuit protection for diverse electronic products, the use of over-current protection devices or over-voltage protection devices increases over time. In statistics, 75% of malfunction of electronic products may be caused by over-current or over-voltage events. In consideration of safety requirements of the electronic products, circuit protection devices have been widely applied thereto.

Because traditional glass tube fuses take up relatively large space and the electrodes are not suitable for being applied to circuit boards, surface-mount device (SMD) type thermal fuses with small volume have been developed. The thermal fuses operate like glass tube fuses; that is, the thermal fuses are conductive in normal operation, and will change to an open-circuit state when ambient temperature exceeds a threshold value. In other words, the thermal fuses switch from conductive state to non-conductive state if temperature reaches the threshold value in an event that over-current passing through the thermal fuses or adjacent devices heats up due to malfunction.

One disadvantage of existing thermal fuses is that during installation of a thermal fuse mounted onto a circuit board, it has to prevent the thermal fuse from reaching the threshold temperature. Otherwise, the thermal fuse changes to an open-circuit state and thus it cannot be used. Therefore, ordinary thermal fuses cannot be mounted onto circuit boards through reflow ovens since reflow ovens usually operate at high temperatures around 230° C. to 260° at which the thermal fuses change to open-circuit state.

The U.S. Pat. No. 8,581,686 devised a reflowable thermal fuse 10, as shown in FIG. 1, comprising a conduction element 11 allowing current flowing therethrough to provide thermal fuse function. The conduction element 11 has resilience going upward and nevertheless is restrained to the substrate 14 by solder 12 at an end. During reflow, solder 12 melts and thereof cannot hold the conduction element 11 in place. To resolve the problem, a restraining element 13 exerts tension for holding the conduction element 11 in place during a reflow process. During normal operations, a load current may flow through the conduction element 11. After blowing the restraining element 13 by electricity, the conduction element 11 is held in place via the solder 12. During an over-current event, excessive heat causes the solder 12 to lose its ability to hold the conduction element 11 in place and the conduction element 11 subsequently springs open as shown. The restraining element 13 may be made of conductive material such as copper, stainless or alloy. The wire diameter of the restraining element 13 has to be taken into account to ensure a current applied thereto can blow and sever the restraining element 13. In other words, a current has to be applied to blow the restraining element 13 after reflow so as to sever the connection with conduction element 11. It is necessary to blow the restraining element 13 by applying a current thereto after reflow, and therefore further process steps and equipment are required. As a consequence, the manufacturing process becomes more complex and costly.

### BRIEF SUMMARY OF THE INVENTION

The present application devises a reflowable thermal fuse in which the restraining element preventing the reflowable thermal fuse in open-circuit state during reflow does not need to be blown after reflow. Accordingly, the installation process of the reflowable thermal fuses and the bonding pad design for surface-mounting onto a circuit board can be simplified.

In accordance with an exemplary embodiment of the present application, a reflowable thermal fuse comprises a base, a housing, an elastic conductive element, a sensor and a restraining element. The base comprises first and second bonding pads for surface-mounting onto a circuit board. The housing combines with the base to form an internal accommodating space, and an upper surface of the housing is provided with an opening. The elastic conductive element is received in the accommodating space and has first and second ends connecting to the first and second bonding pads, respectively. The elastic conductive element is operable to exert a resilient force which is able to sever the connection between the second end and the second bonding pad. The sensor connects to the second end of the elastic conductive element and the second bonding pad to form electrical connection. The restraining element comprises a pressing member going through the opening of the housing and pressing the second end to resist the resilient force of the elastic conductive element during reflow. After reflow, the restraining element is removed and thereby the reflowable thermal fuse is in an activation state. When temperature has yet to reach a threshold value, the elastic conductive element still connects to the second bonding pad and sustains electrical connection. Under a fault condition of high temperature in an event that, for example, over-current occurs or adjacent devices heats up due to malfunction, the force exerted by the elastic element separates the second end from the second bonding pad to sever electrical connection. In other words, the second end of the elastic conductive element separates from the second bonding pad if the sensor heats up to a threshold temperature or ambient temperature of the reflowable thermal fuse reaches a threshold value. More specifically, the sensor may be melted to sever the connection between the second end of the elastic conductive element and the second bonding pad, and then the elastic conductive element returns to its original shape via its resilience to disconnect the elastic conductive element and the second bonding pad.

In an exemplary embodiment, the sensor comprises solder.

In an exemplary embodiment, the first and second bonding pads are at least partially exposed on bottom of the base for being surface-mounted onto a circuit board.

In an exemplary embodiment, the restraining element further comprises a hook to engage with the housing or the base. For example, the hook engages with a bottom of the base or sidewalls of the housing.

In an exemplary embodiment, the hook may comprise two arms extending along two sidewalls of the housing. Two inward protrusions are formed at bottom-ends of the two arms to engage with the bottom of the base or sidewalls of the housing. The protrusions may be in the form of semi-circular shape, bevel shape or combinations thereof to facilitate removal of the restraining element after reflow.

In an exemplary embodiment, the sidewalls of the housing are provided with openings through which the protrusions are inserted.

In an exemplary embodiment, the elastic conductive element is of an arch shape.

In an exemplary embodiment, the first and second bonding pads connect to metal electrodes extending out of the housing for spot-welding, in place of soldering, the reflowable thermal fuse to the circuit board.

After reflow and the restraining element is removed, the reflowable thermal fuse is in an activation state. If the second end of the elastic conductive element and the second bonding pad are disconnected for electrical inspection or the disconnection is caused by unexpected over-heat, the restraining element can be reinstalled and soldered to the second bonding pad by an electric soldering iron.

The restraining element of the reflowable thermal fuse is secured by mechanical manner so as to acquire high reliability. After reflow, the restraining element is removed by mechanical operation, and therefore the step of blowing the restraining element by electricity is not needed. In addition to high reliability, the reflowable thermal fuse of the present application can effectively simplify manufacturing process and equipment.

### BRIEF DESCRIPTION OF THE SEVERAL VIEWS OF THE DRAWINGS

The present application will be described according to the appended drawings in which:

FIG. 1 shows a known reflowable thermal fuse;

FIG. 2 shows a perspective view of a reflowable thermal fuse in accordance with a first embodiment of the present application;

FIG. 3 shows an exploded perspective view of a base and a housing of the reflowable thermal fuse of FIG. 2;

FIGS. 4 and 5 show internal perspective views of the reflowable thermal fuse of FIG. 2 at different states;

FIG. 6 shows a perspective view of a reflowable thermal fuse in accordance with a second embodiment of the present application;

FIG. 7 shows an exploded perspective view of the reflowable thermal fuse of FIG. 6;

FIG. 8 and FIG. 9 show internal perspective views of the reflowable thermal fuse of FIG. 6 at different states; and

FIG. 10 shows a perspective view of a reflowable thermal fuse in accordance with a third embodiment of the present application.

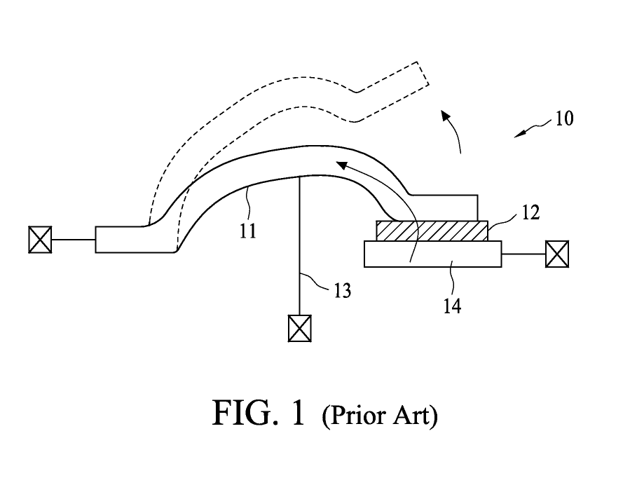

### DETAILED DESCRIPTION OF THE INVENTION

The making and using of the presently preferred illustrative embodiments are discussed in detail below. It should be appreciated, however, that the present application provides many applicable inventive concepts that can be embodied in a wide variety of specific contexts. The specific illustrative embodiments discussed are merely illustrative of specific ways to make and use the invention, and do not limit the scope of the invention.

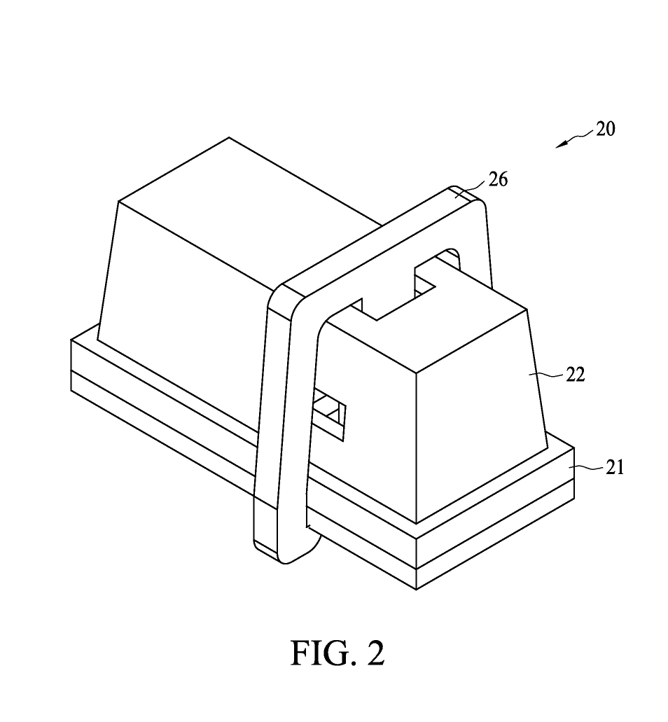

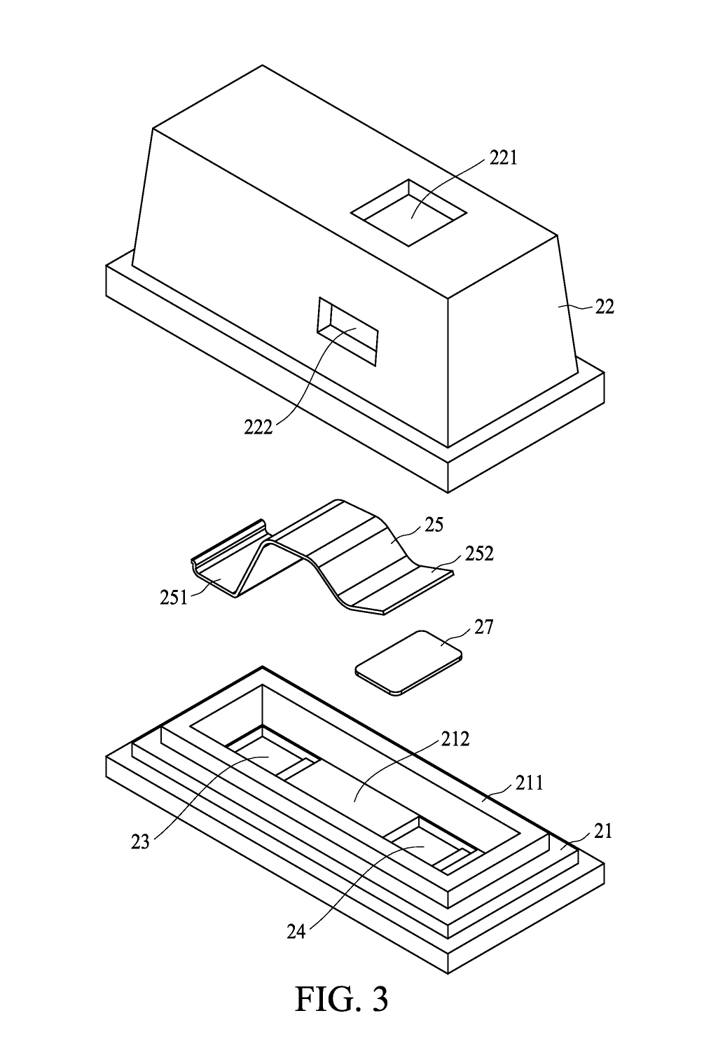

In order to prevent open circuit resulted from separating the elastic conductive element from the bonding pad of the thermal fuse during high-heat reflow process, a restraining element is utilized to resist the force causing open-circuit. FIGS. 2 to 5 show a reflowable thermal fuse in accordance with a first embodiment of the present application. FIG. 2 shows a perspective view of a reflowable thermal fuse 20 comprising a base 21, a housing 22 associating with the base 21, and a restraining element 26. FIG. 3 shows an exploded view of the reflowable thermal fuse 20 excluding the restraining element 26. In this embodiment, the base 21 has a step-like perimeter 211 forming a concave in which a bottom plate 211 is provided with a first bonding pad 23 and a second bonding pad 24. The first and second bonding pads 23 and 24 are at least partially exposed on the bottom of the base 21 for being surface-mounted onto a circuit board. The housing 22 is a hollow rectangular cuboid with lower perimeter configured to engage with the perimeter 211 of the base 21, so as to form an internal accommodating space after assembly of the housing 22 and the base 21. Optionally, the housing 22 has an upper surface with an opening 221 and two sidewalls with openings 222. The elastic conductive element 25 is in arch shape and is received in the internal accommodating space. The elastic conductive element 25 has a first end 251 connecting to the first bonding pad 23 and a second end 252 connecting to the second bonding pad 24. The elastic conductive element 25 is able to exert a resilient force to sever the connection with the second bonding pad 24. The sensor 27 is placed between the second end 252 of the elastic conductive element 25 and the second bonding pad 24 to connect the elastic conductive element 25 and the second bonding pad for establishing electrical connection therebetween. When the sensor 27 detects a temperature exceeding a threshold value, the elastic conductive element 25 is separated from the second bonding pad 24 to sever electrical connection. In an embodiment, the sensor 27 comprises solder. Solder will be melted and is no longer able to resist the resilient force when temperature reaches the melting point of the solder, and as a result the second end 252 of the elastic conductive element 25 springs upward and separates from the second bonding pad 24 to form an open-circuit thereby providing fuse protection.

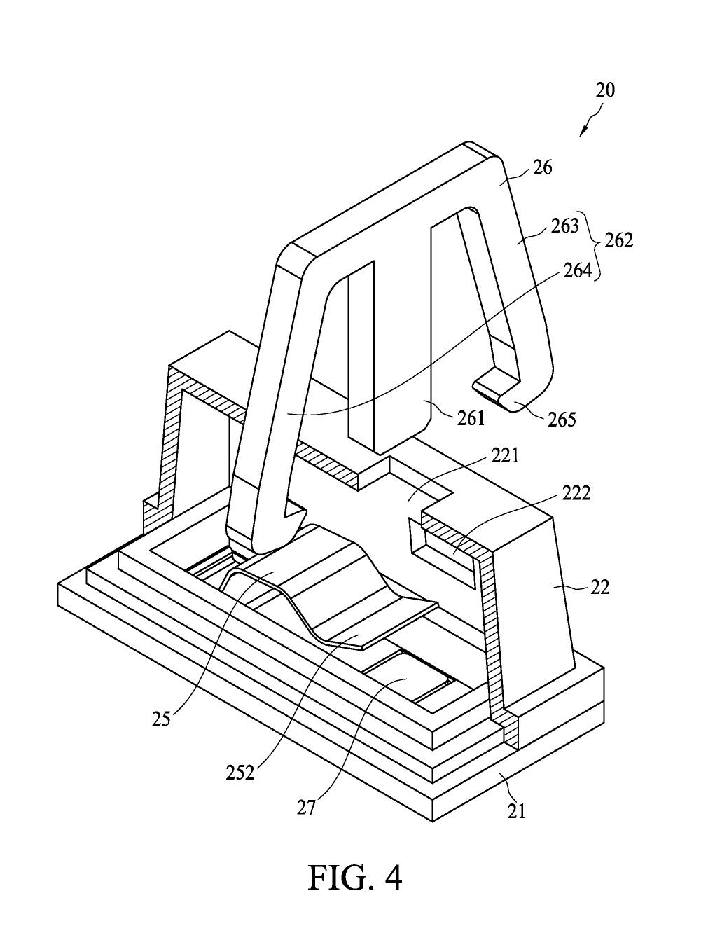

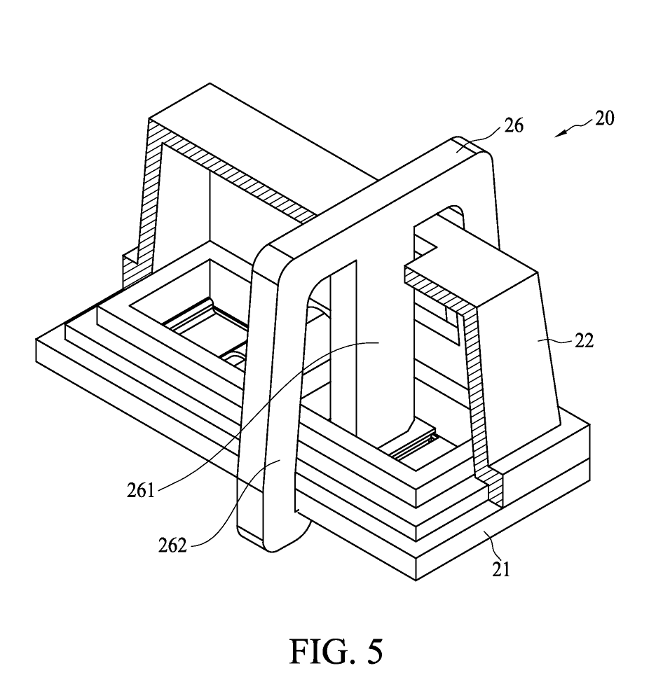

FIGS. 4 and 5 show internal perspective views of the reflowable thermal fuse 20 in which the restraining element 26 holding and unholding the elastic conductive element 25 in place, respectively. In an embodiment, the restraining element 26 comprises a pressing member 261 which penetrates through the opening 221 and its bottom-end presses the second end 252 of the elastic conductive element 25 to resist the resilient force of the elastic conductive element 25 during reflow. The restraining element 26 has a hook 262 extending along two sides to mechanically engage with bottom of the base 21. More specifically, the hook 262 comprises arms 263 and 264 of which the ends are provided with inward protrusions 265 for engaging with the base 21.

In another embodiment, the hook 262 engages with sidewalls of the housing 22. That is, the protrusions 265 insert into the openings 222 on the sidewalls of the housing 22. It is noted that the hooks 262 may have shorter arms 263 and 264 in this embodiment. For the ease of removing the restraining element 26 operable to hold the elastic conductive element 25 after reflow, i.e., separating the restraining element 26 from the base 21 or housing 22 engaged therewith, the protrusions 265 at the ends of the arms 263 and 264 may be in a semi-circular shape, a bevel shape or combinations thereof. The openings 222 of the housing 22 can be made in corresponding semi-circular shape or a bevel shape, so that the restraining element 26 can be easily removed by one-hand or mechanical operation.

After reflow of the reflowable thermal fuse 20, the restraining element 26 has to be removed, and thereby the reflowable thermal fuse 20 is in an activated state at which the elastic conductive element 25 and the second bonding pad 24 are connected to establish electrical connection therebetween. Under a fault condition of high temperature, the sensor 27 is melted and as a consequence the second end 252 of the elastic conductive element 25 is separated from the second bonding pad 24. In other words, the sensor 27 severs the connection of the second end 252 of the elastic conductive element 25 and the second bonding pad 24 if ambient temperature of the reflowable thermal fuse 20 exceeds a threshold value.

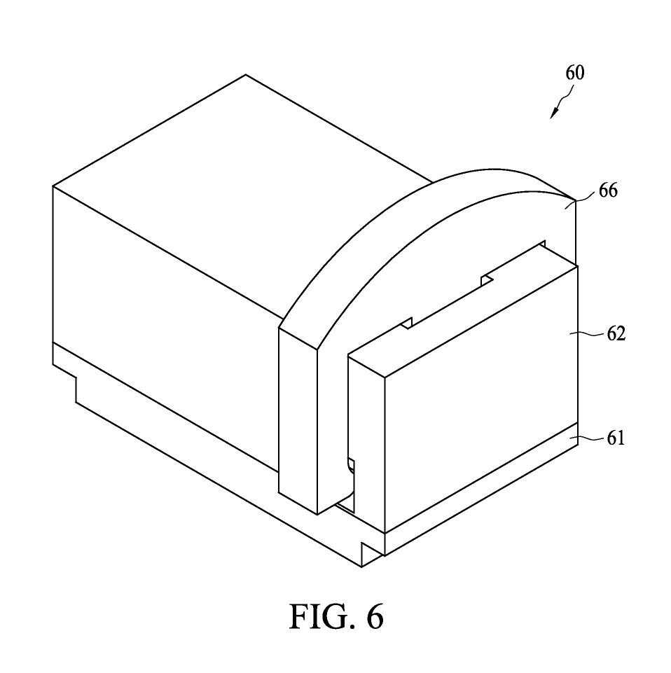

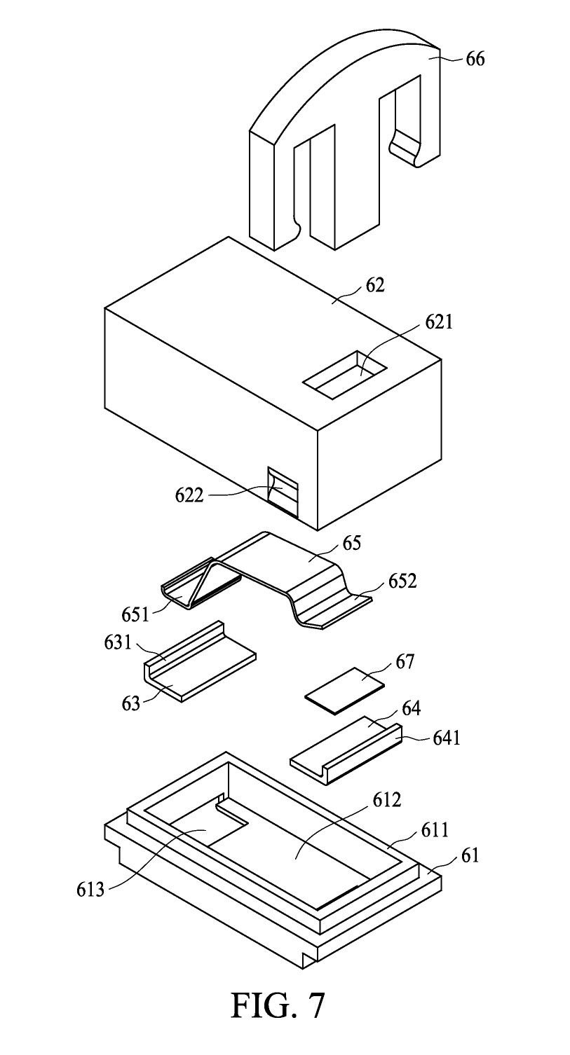

FIGS. 6 to 9 show a reflowable thermal fuse in accordance with a second embodiment of the present application. FIG. 6 shows a perspective view of a reflowable thermal fuse 60 comprising a base 61, a housing 62 associated with the base 61, and a restraining element 66. FIG. 7 shows an exploded view of the reflowable thermal fuse 60. The base 61 has perimeter 611 forming a concave in which a bottom plate 612 is provided with openings 613 corresponding to a first bonding pad 63 and a second bonding pad 64. The first and second bonding pads 63 and 64 are at least partially exposed on bottom of the base 61 for being surface-mounted onto a circuit board. The first bonding pad 63 comprises an upright portion 631, whereas the second bonding pad 64 comprises an upright portion 641. The upright portions 631 and 641 are exposed on sidewalls of the housing 61 after assembly, so that solder wicking phenomenon after surface-mounting onto a circuit board can be inspected to verify the quality of soldering. The housing 62 is a hollow rectangular cuboid with lower perimeter capable of engaging with the perimeter 611 of the base 61, so as to form an internal accommodating space after assembly of the housing 62 and the base 61. The housing 62 has an upper surface with an opening 621 and two sidewalls with openings 622. The elastic conductive element 65 is in arch shape and is received in the internal accommodating space. The elastic conductive element 65 has a first end 651 connecting to the first bonding pad 63 and a second end 652 connecting to the second bonding pad 64. The elastic conductive element 65 is able to exert a resilient force to sever the connection with the second bonding pad 64. The sensor 67 is placed between the second end 652 of the elastic conductive element 65 and the second bonding pad 64, so as to connect the elastic conductive element 65 and the second bonding pad 64 for electrical connection. When the sensor 67 detects a temperature exceeding a threshold value, the elastic conductive element 65 is separated from the second bonding pad 64 to sever electrical connection. In an embodiment, the sensor 67 comprises solder. Solder will be melted and is no longer able to resist the resilient force of the elastic conductive element 65 when temperature reaches the melting point of the solder. As a result, the second end 652 of the elastic conductive element 65 springs upward and separates from the second bonding pad 64 to form an open-circuit thereby providing fuse protection.

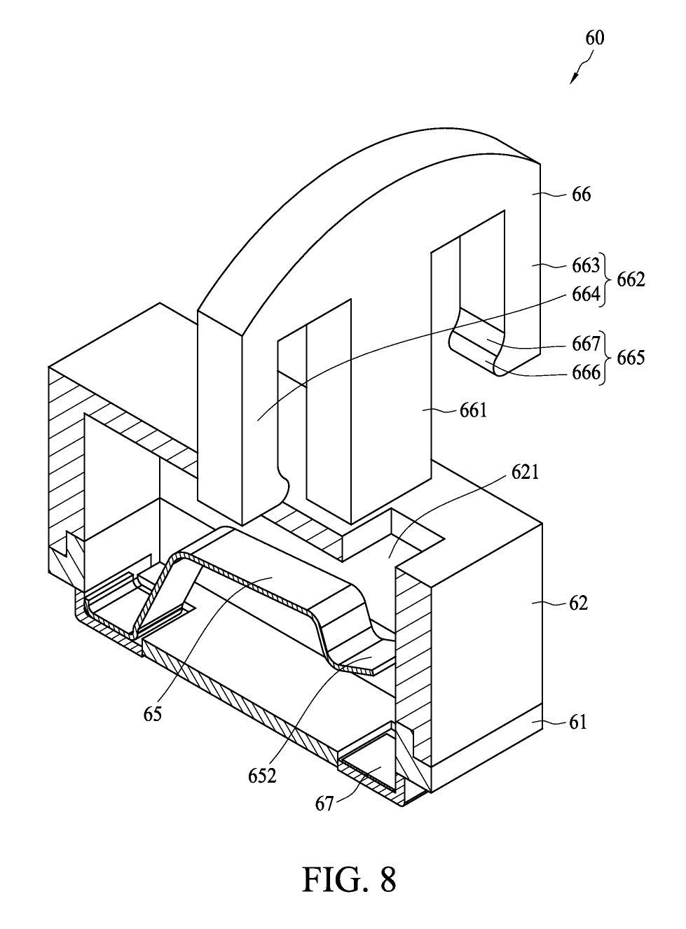

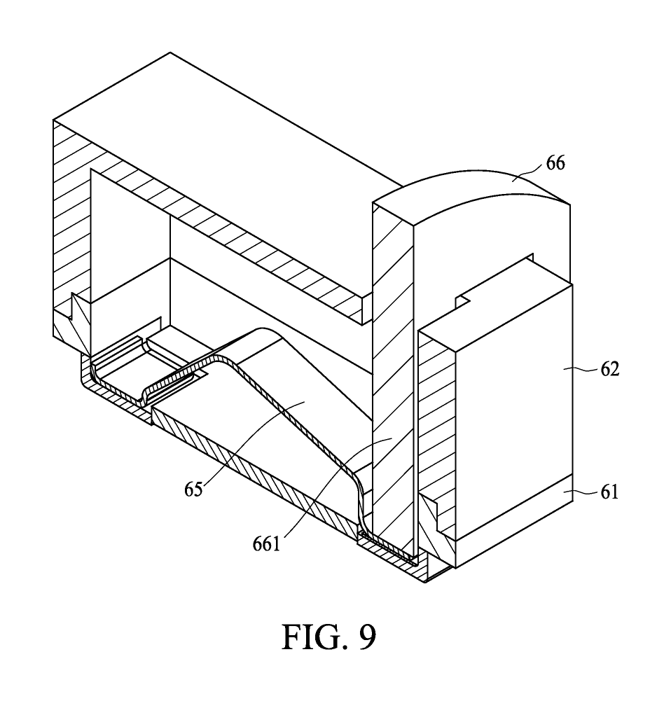

FIGS. 8 and 9 show internal perspective views of the reflowable thermal fuse 60 in which the restraining element 66 holding and unholding the elastic conductive element 65 in place, respectively. In an embodiment, the restraining element 66 comprises a pressing member 661 which penetrates through the opening 621 and presses the second end 652 of the elastic conductive element 65 to resist the resilient force of the elastic conductive element 65 during reflow. The restraining element 66 has a hook 662 extending downward. More specifically, arms 663 and 664 extend along the sidewalls of the housing 62 and the ends are provided with inward protrusions 665 corresponding to the openings 622 for engaging with the housing 62. In an embodiment, the protrusion 665 may comprise semicircular member 666 and bevel member 667 for the ease of separating the restraining element 66 from the housing 62.

After reflow, the restraining element 66 has to be taken out, and thereby the reflowable thermal fuse 60 is in an activation state at which the elastic conductive element 65 and the second bonding pad 64 are still connected to sustain electrical connection. When high-heat fault occurs, the second end 652 of the elastic conductive element 65 is separated from the second bonding pad 64. In other words, the sensor 67 is melted to sever the connection between the second end 652 of the elastic conductive element 65 and the second bonding pad 64 when the ambient temperature of the reflowable thermal fuse 60 exceeds a threshold value.

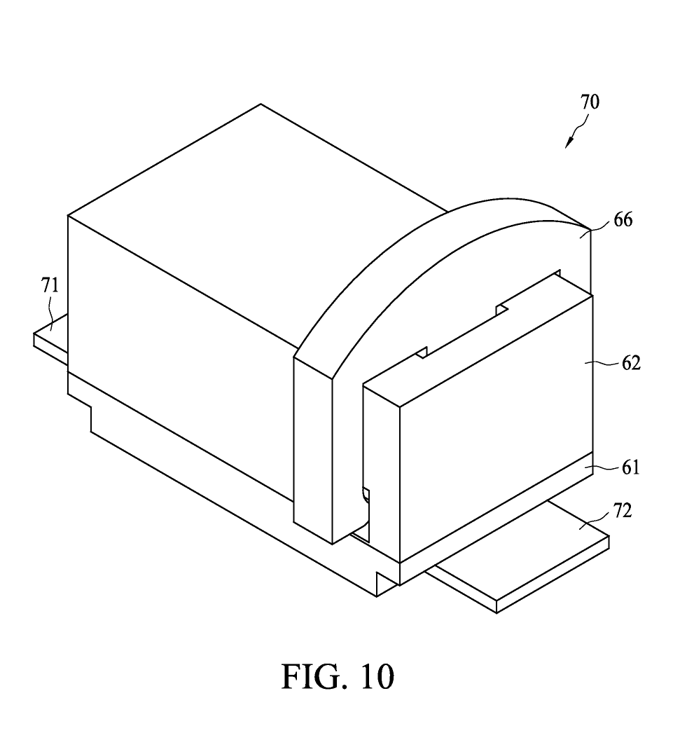

FIG. 10 shows a perspective view of a reflowable thermal fuse 70 in accordance with a third embodiment of the present application. The reflow thermal fuse 70 is similar to that of the reflowable thermal fuse 60 except that the first bonding pad 63 and the second bonding pad 64 further connect to metal electrodes 71 and 72 extending out of the housing 62, respectively. Besides the way of soldering, the reflowable thermal fuse 70 maybe mounted to a circuit board by spot-welding through the metal electrodes 71 and 72 alternatively. The metal electrode 71 and the first bonding pad 63 may be formed integrally, whereas the metal electrode 72 and the second bonding pad 64 may be formed integrally, e.g., they may be made of a single metal sheet.

Upon simple mechanism design of the reflowable thermal fuse, the restraining element can be easily removed by manual or mechanical operation. Unlike traditional restraining element has to be blown by electricity, the process and equipment of the reflowable thermal fuse of the present application can be simplified and the cost can be reduced accordingly. After reflow and the restraining element is removed, the reflowable thermal fuse of the present application is in an activation state. If the second end of the elastic conductive element and the second bonding pad are disconnected for electrical inspection or unexpected over-heat, the restraining element can be reinstalled and soldered to the second bonding pad by an electric soldering iron. The aforesaid embodiments are illustrative only and are not limitation to the present application. Numerous ways to mechanically press or hold the elastic conductive element in place and to take out the restraining element by manual or mechanical operation rather than electricity are covered by the present application.

The above-described embodiments of the present invention are intended to be illustrative only. Numerous alternative embodiments may be devised by persons skilled in the art without departing from the scope of the following claims.

We claim:

1. A reflowable thermal fuse, comprising:
a base comprising first and second bonding pads;
a housing associating with the base to form an internal accommodating space, the housing having an upper surface with an opening;
an elastic conductive element received in the internal accommodating space and comprising first and second ends connecting to the first and second bonding pads, respectively; the elastic conductive element being operable to exert a resilient force which is able to sever the connection between the second end and the second bonding pad;
a sensor connecting to the second end and the second bonding pad to establish electrical connection therebetween; and
a restraining element comprising a pressing member going through the opening of the housing and pressing the second end to resist the resilient force exerted by the elastic conductive element during reflow;
wherein the restraining element is removed after reflow and thereby the reflowable thermal fuse is in an activation condition, and the resilient force exerted by the elastic conductive element separates the second end from the second bonding pad if the sensor detects a temperature over a threshold value.

2. The reflowable thermal fuse of claim 1, wherein the sensor is melted to sever the connection between the second end of the elastic conductive element and the second bonding pad if ambient temperature of the reflowable thermal fuse exceeds a threshold value.

3. The reflowable thermal fuse of claim 1, wherein the sensor comprises solder.

4. The reflowable thermal fuse of claim 1, wherein the first and second bonding pads are at least partially exposed on bottom of the base for being surface-mounted onto a circuit board.

5. The reflowable thermal fuse of claim 1, wherein the restraining element further comprises a hook to engage with the housing or the base.

6. The reflowable thermal fuse of claim 5, wherein the hook engages with a bottom of the base.

7. The reflowable thermal fuse of claim 5, wherein the hook engages with sidewalls of the housing.

8. The reflowable thermal fuse of claim 5, wherein the hook comprises two arms extending along two sidewalls of the housing and two inward protrusions at the ends of the two arms to engage with bottom of the base or sidewalls of the housing.

9. The reflowable thermal fuse of claim 8, wherein the sidewalls of the housing are provided with openings in which the inward protrusions insert.

10. The reflowable thermal fuse of claim 8, wherein the inward protrusions are in the form of semi-circular shape, bevel shape or combinations thereof.

11. The reflowable thermal fuse of claim 1, wherein the elastic conductive element is in an arch shape.

12. The reflowable thermal fuse of claim 1, wherein the first and second bonding pads comprise upright portions exposed on sidewalls of the base.

13. The reflowable thermal fuse of claim 1, wherein the first and second bonding pads connect to metal electrodes extending out of the housing for spot-welding.
